(19) United States
(12) Patent Application Publication
(10) Pub. No.: US 2023/0151821 A1
(43) Pub. Date: May 18, 2023

(54) AIR-CONDITIONING APPARATUS AND REFRIGERATION CYCLE APPARATUS [AS AMENDED]

(71) Applicant: Mitsubishi Electric Corporation, Tokyo (JP)

(72) Inventors: Takuya TERAMOTO, Tokyo (JP); Ryo HORIE, Tokyo (JP); Takahiro YAMATANI, Tokyo (JP); Kazuya MICHIKAMI, Tokyo (JP); Hiroshi TSUTSUMI, Tokyo (JP); Hiroyasu HAYASHI, Tokyo (JP)

(21) Appl. No.: 18/155,888

(22) Filed: Jan. 18, 2023

Related U.S. Application Data
(63) Continuation of application No. 16/755,732, filed on Apr. 13, 2020, now Pat. No. 11,592,032.

(51) Int. Cl. F04D 29/42; F04D 29/58; F25D 17/06

(52) U.S. Cl. CPC F04D 29/4233; F04D 29/5826; F25D 17/067; F05D 2250/52; F05D 2250/70; F04D 25/08

(57) ABSTRACT

An air conditioning apparatus includes a centrifugal fan and a heat exchanger disposed in a position facing a discharge port of the centrifugal fan. The centrifugal fan includes: a fan, blades; and a scroll casing housing the fan, the scroll casing including a discharge portion, and a scroll portion including a side wall, a circumferential wall, and a tongue portion. In the circumferential wall, at a first end between the circumferential wall and the tongue portion, and at a second end between the circumferential wall and the discharge portion, a distance between an axis of the rotational shaft and the circumferential wall is equal to a distance between the axis of the rotational shaft and a standard circumferential wall, and is greater than or equal to the distance between the first end and the second end of the circumferential wall, the circumferential wall including an extended portion between the first end and the second end of the circumferential wall and bulging out, at a position facing the circumferential portion of the main plate, in a direction parallel to the rotational shaft.

### TECHNICAL FIELD

The present disclosure relates to a centrifugal fan including a scroll casing, and an air-sending device, an air-conditioning apparatus, and a refrigeration cycle apparatus including the centrifugal fan.

### BACKGROUND ART

Some centrifugal fans of the related art include a circumferential wall provided in a logarithmic spiral shape in which the distance between an axis of a fan and a circumferential wall of a scroll casing is sequentially extended from the downstream side to the upstream side of the air flow flowing in the scroll casing. In such a centrifugal fan, when the extension rate of the distance between the axis of the fan and the circumferential wall of the scroll casing is not sufficiently large in the direction of the air flow in the scroll casing, not only does the pressure recovery from the dynamic pressure to the static pressure is insufficient and the air-sending efficiency decreases, but the loss also increases and the noise also worsens. Thus, a centrifugal fan including an external form formed in a spiral shape and two substantially-parallel linear portions provided on the external form is proposed (for example, see Patent Literature 1). In the centrifugal fan, one linear portion out of the linear portions is connected to a discharge port in a scroll, and a rotational shaft of a motor is located near the linear portion close to a tongue portion of the scroll. Since a sirocco fan in Patent Literature 1 includes the above-mentioned configuration, a reverse flow phenomenon can be suppressed and the noise value can be reduced while maintaining a predetermined air volume.

### CITATION LIST

### Patent Literature

Patent Literature 1: Japanese Patent No. 4906555

### SUMMARY OF INVENTION

### Technical Problem

However, in the centrifugal fan in Patent Literature 1, which can improve the noise problem, may suffer from a decrease in the air-sending efficiency because of insufficient pressure recovery from the dynamic pressure to the static pressure when the extension rate of the circumferential wall of the scroll casing to a predetermined direction cannot be sufficiently secured due to a restriction in the external dimensions depending on the place of installation.

An object of the present disclosure, which has been made to solve the above-mentioned problems, is to obtain a centrifugal fan, an air-sending device, an air-conditioning apparatus, and a refrigeration cycle apparatus configured to reduce noise and improve the air-sending efficiency.

### Solution to Problem

According to an embodiment of the present disclosure, there is provided a centrifugal fan comprising: a fan including a main plate having a disk-shape, and a plurality of blades installed on a circumferential portion of the main plate; and a scroll casing configured to house the fan, the scroll casing including a discharge portion forming a discharge port from which an air flow generated by the fan is discharged, and a scroll portion including a side wall covering the fan in an axis direction of a rotational shaft of the fan, and formed with a suction port configured to suction air, a circumferential wall encircling the fan in a radial direction of the rotational shaft, and a tongue portion provided between the discharge portion and the circumferential wall, and configured to guide the air flow generated by the fan to the discharge port. In comparison with a centrifugal fan including a standard circumferential wall having a logarithmic spiral shape in cross-section perpendicular to the rotational shaft of the fan, in the circumferential wall, at a first end being a boundary between the circumferential wall and the tongue portion and at a second end being a boundary between the circumferential wall and the discharge portion, a distance L1 between an axis of the rotational shaft and the circumferential wall is equal to a distance L2 between the axis of the rotational shaft and the standard circumferential wall, the distance L1 is greater than or equal to the distance L2 between the first end and the second end of the circumferential wall, the circumferential wall includes a plurality of extended portions between the first end and the second end of the circumferential wall, and the plurality of extended portions include maximum points each have a length being a difference LH between the distance L1 and the distance L2.

### Advantageous Effects of Disclosure

In the centrifugal fan according to an embodiment of the present disclosure, in comparison with the centrifugal fan including the standard circumferential wall having a logarithmic spiral shape in cross-section perpendicular to the rotational shaft of the fan, in the circumferential wall, at the first end and at the second end, the distance L1 is equal to the distance L2. In the circumferential wall, between the first end and the second end of the circumferential wall, the distance L1 is greater than or equal to the distance L2. The circumferential wall includes the plurality of extended portions between the first end and the second end of the circumferential wall, and the plurality of extended portions include maximum points each having a length being a difference LH between the distance L1 and the distance L2. Therefore, in the centrifugal fan, even when the extension rate of the circumferential wall of the scroll casing to a predetermined direction cannot be sufficiently secured due to the restriction in the external dimensions depending on the place of installation, the distance of an air passage in which the distance between the axis of the rotational shaft and the circumferential wall is extended can be increased because the circumferential wall includes the configuration above in the extendable direction. As a result, the centrifugal fan can convert the dynamic pressure to the static pressure by reducing the speed of the air flow flowing in the scroll casing while preventing the separation of the air flow, and hence can improve the air-sending efficiency while reducing the noise.

### BRIEF DESCRIPTION OF DRAWINGS

FIG. 1 is a perspective view of a centrifugal fan according to Embodiment 1 of the present disclosure.

FIG. 2 is a top view of the centrifugal fan according to Embodiment 1 of the present disclosure.

FIG. 3 is a cross-sectional view of the centrifugal fan in FIG. 2 taken along line D-D.

FIG. 4 is a top view illustrating a comparison between a circumferential wall of the centrifugal fan according to Embodiment 1 of the present disclosure and a standard circumferential wall of a centrifugal fan of the related art having a logarithmic spiral shape.

FIG. 5 shows the relationship between an angle θ [degree] and a distance L [mm] from an axis to a circumferential wall surface in the centrifugal fan 1 or the centrifugal fan of the related art in FIG. 4.

FIG. 6 is a graph obtained by changing extension rates of extended portions in the circumferential wall of the centrifugal fan according to Embodiment 1 of the present disclosure.

FIG. 7 shows the differences between the extension rates of the extended portions in the circumferential wall of the centrifugal fan according to Embodiment 1 of the present disclosure.

FIG. 8 is a top view illustrating a comparison between a circumferential wall of the centrifugal fan according to Embodiment 1 of the present disclosure having other extension rates and the standard circumferential wall SW of the centrifugal fan of the related art having a logarithmic spiral shape.

FIG. 9 is a graph obtained by changing the other extension rates of the extended portions in the circumferential wall of the centrifugal fan in FIG. 8.

FIG. 10 is a top view illustrating a comparison between a circumferential wall of the centrifugal fan according to Embodiment 1 of the present disclosure having other extension rates, and the standard circumferential wall SW of the centrifugal fan of the related art having a logarithmic spiral shape.

FIG. 11 is a graph obtained by changing the other extension rates of the extended portions in the circumferential wall of the centrifugal fan in FIG. 10.

FIG. 12 shows the other extension rates in the circumferential wall of the centrifugal fan according to Embodiment 1 in FIG. 5.

FIG. 13 is a top view illustrating a comparison between the circumferential wall of the centrifugal fan according to Embodiment 1 of the present disclosure having other extension rates and the standard circumferential wall SW of the centrifugal fan of the related art having a logarithmic spiral shape.

FIG. 14 is a graph obtained by changing the other extension rates of the extended portions in the circumferential wall of the centrifugal fan in FIG. 13.

FIG. 15 is a cross-sectional view of a centrifugal fan according to Embodiment 2 of the present disclosure taken along the axis direction.

FIG. 16 is a cross-sectional view of a modified example of the centrifugal fan according to Embodiment 2 of the present disclosure taken along the axis direction.

FIG. 17 is a cross-sectional view of another modified example of the centrifugal fan according to Embodiment 2 of the present disclosure taken along the axis direction.

FIG. 18 illustrates a configuration of an air-sending device according to Embodiment 3 of the present disclosure.

FIG. 19 is a perspective view of an air-conditioning apparatus according to Embodiment 4 of the present disclosure.

FIG. 20 illustrates an inner configuration of the air-conditioning apparatus according to Embodiment 4 of the present disclosure.

FIG. 21 is a cross-sectional view of the air-conditioning apparatus according to Embodiment 4 of the present disclosure.

FIG. 22 illustrates a configuration of a refrigeration cycle apparatus according to Embodiment 5 of the present disclosure.

### DESCRIPTION OF EMBODIMENTS

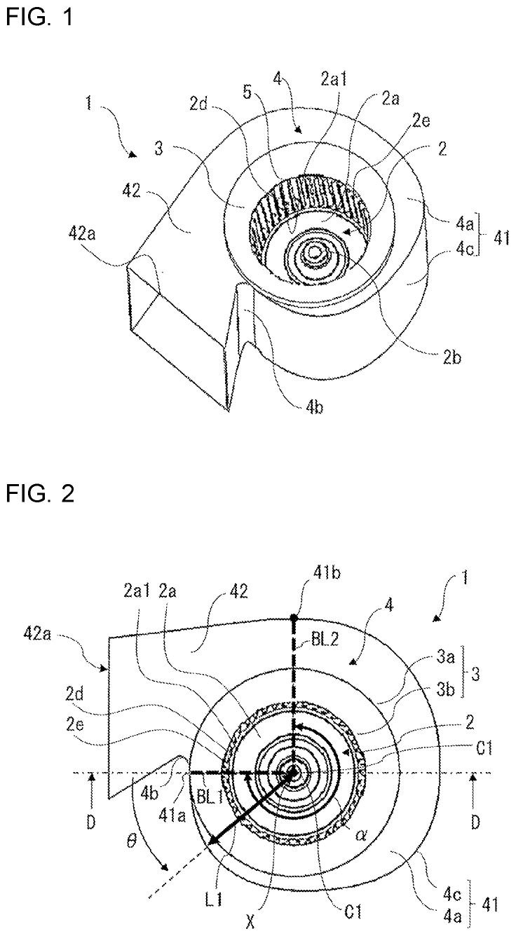

A centrifugal fan 1, an air-sending device 30, an air-conditioning apparatus 40, and a refrigeration cycle apparatus 50 according to embodiments of the present disclosure are described below with reference to the drawings, for example. Note that, in the drawings below including FIG. 1, the relationships between relative dimensions, shapes and other features of configuration parts may differ from actual ones. In the drawings below, parts denoted by the same reference characters are the same parts or parts equivalent thereto, and the above is common throughout the entire description. Terms (for example, “up”, “down”, “right”, “left”, “front”, and “rear”) indicating directions are used, as appropriate, for facilitating understanding, but those expressions are described as above for the sake of convenience, and the arrangement and the orientations of the devices or the parts are not limited thereby.

### Embodiment 1

### Centrifugal Fan 1

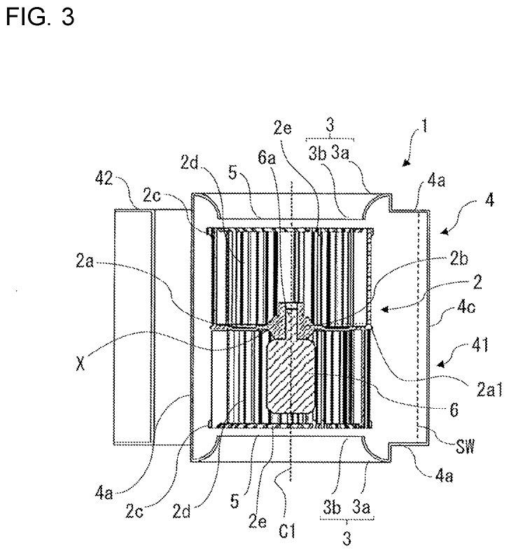

FIG. 1 is a perspective view of a centrifugal fan 1 according to Embodiment 1 of the present disclosure. FIG. 2 is a top view of the centrifugal fan 1 according to Embodiment 1 of the present disclosure. FIG. 3 is a cross-sectional view of the centrifugal fan 1 in FIG. 2 taken along line D-D. A basic structure of the centrifugal fan 1 is described with reference to FIG. 1 to FIG. 3. Note that the dotted line shown in FIG. 3 is a standard circumferential wall SW in cross-section showing a circumferential wall of a centrifugal fan of the related art. The centrifugal fan 1 is a multi-wing centrifugal-type centrifugal fan, and includes a fan 2 configured to generate air flow, and a scroll casing 4 configured to house the fan 2.

### (Fan 2)

The fan 2 includes a main plate 2a having a disk-shape, and a plurality of blades 2d installed on a circumferential portion 2a1 of the main plate 2a. The fan 2 includes ring-shaped side plates 2c facing the main plate 2a. The ring-shaped side plates 2c are placed on ends of the fan 2 opposite to the main plate 2a of the plurality of blades 2d. Note that the fan 2 may have a structure not including the side plates 2c. When the fan 2 includes the side plates 2c, the plurality of blades 2d each have one end being connected to the main plate 2a and the other end being connected to each of the side plates 2c, and the plurality of blades 2d are disposed between the main plate 2a and the side plates 2c. A boss portion 2b is provided on the center portion of the main plate 2a. An output shaft 6a of a fan motor 6 is connected to the center of the boss portion 2b, and the fan 2 rotates by a driving force of the fan motor 6. The fan 2 forms a rotational shaft X by the boss portion 2b and the output shaft 6a. The plurality of blades 2d encircle the rotational shaft X of the fan 2 between the main plate 2a and the side plates 2c. The fan 2 is formed in a cylindrical shape by the main plate 2a and the plurality of blades 2d, and suction ports 2e are formed on side plate 2c sides opposite to the main plate 2a in the axis direction of the rotational shaft X of the fan 2. As shown in FIG. 3, the fan 2 has the plurality of blades 2d provided on both sides of the main plate 2a in the axis direction of the rotational shaft X. Note that the configuration of the fan 2 is not limited to a configuration in which the plurality of blades 2d are provided on both sides of the main plate 2a in the axis direction of the rotational shaft X, and the plurality of blades 2d may be provided on only one side of the main plate 2a in the axis direction of the rotational shaft X, for example. As shown in FIG. 3, in the fan 2, the fan motor 6 is disposed on an inner peripheral side of the fan 2, but the output shaft 6a only needs to be connected to the boss portion 2b in the fan 2, and the fan motor 6 may be disposed outside of the centrifugal fan 1.

### (Scroll Casing 4)

The scroll casing 4 encircles the fan 2, and rectifies the air blown out from the fan 2. The scroll casing 4 includes a discharge portion 42 configured to form a discharge port 42a from which the air flow generated by the fan 2 is discharged, and a scroll portion 41 configured to form an air passage configured to convert the dynamic pressure of the air flow generated by the fan 2 to the static pressure. The discharge portion 42 forms the discharge port 42a from which the air flow passing through the scroll portion 41 is discharged. The scroll portion 41 includes side walls 4a covering the fan 2 in the axis direction of the rotational shaft X of the fan 2 and formed with suction ports 5 configured to suction air, and a circumferential wall 4c encircling the fan 2 in the radial direction of the rotational shaft X. The scroll portion 41 includes a tongue portion 4b provided between the discharge portion 42 and the circumferential wall 4c and configured to guide the air flow generated by the fan 2 to the discharge port 42a via the scroll portion 41. Note that the radial direction of the rotational shaft X is a direction perpendicular to the rotational shaft X. An inner space in the scroll portion 41 made of the circumferential wall 4c and the side walls 4a is a space in which the air blown out from the fan 2 flows along the circumferential wall 4c.

### (Side Walls 4a)

The suction ports 5 are formed in the side walls 4a of the scroll casing 4. On the side walls 4a, bell mouths 3 configured to guide the air flow suctioned into the scroll casing 4 through the suction ports 5, are provided. The bell mouths 3 are formed in positions facing the suction ports 2e of the fan 2. Each of the bell mouths 3 has a shape in which the air passage narrows from an upstream end 3a being an end on the upstream side of the air flow suctioned into the scroll casing 4 through the suction ports 5, toward a downstream end 3b being an end on the downstream side. As shown in FIG. 1 to FIG. 3, the centrifugal fan 1 includes a double-suction scroll casing 4 including the side walls 4a in which the suction ports 5 are formed on both sides of the main plate 2a in the axis direction of the rotational shaft X. Note that the centrifugal fan 1 is not limited to a configuration including the double-suction scroll casing 4, and may include the single-suction scroll casing 4 including the side wall 4a in which the suction port 5 is formed on one side of the main plate 2a in the axis direction of the rotational shaft X.

### (Circumferential Wall 4c)

The circumferential wall 4c encircles the fan 2 in the radial direction of the rotational shaft X, and forms an inner peripheral surface facing the plurality of blades 2d forming an outer peripheral surface of the fan 2 in the radial direction. The circumferential wall 4c has a width in the axis direction of the rotational shaft X, and is formed in a spiral shape in top view. As shown in FIG. 2, the circumferential wall 4c is provided in a portion from a first end 41a positioned in the boundary between the scroll portion 41 and the tongue portion 4b to a second end 41b positioned in the boundary between the discharge portion 42 and the scroll portion 41 on the side far from the tongue portion 4b along the direction of rotation of the fan 2. The inner peripheral surface of the circumferential wall 4c forms a curved surface smoothly forming a curve from the first end 41a being the start of the winding of the spiral shape to the second end 41b being the end of the winding of the spiral shape along the circumferential direction of the fan 2. The first end 41a is an edge portion on the upstream side of the air flow generated by the rotation of the fan 2, and the second end 41b is an edge portion on the downstream side of the air flow generated by the rotation of the fan 2 in the circumferential wall 4c forming the curved surface.

An angle θ shown in FIG. 2 is an angle shifted from a first reference line BL in the direction of rotation of the fan 2 between a first reference line BL1 connecting an axis C1 of the rotational shaft X and the first end 41a to each other and a second reference line BL2 connecting the axis C1 of the rotational shaft X and the second end 41b to each other in cross-section perpendicular to the rotational shaft X of the fan 2. The angle θ of the first reference line BL1 shown in FIG. 2 is 0 degrees. Note that the angle of the second reference line BL2 is an angle α, and does not indicate a predetermined value. This is because the angle α of the second reference line BL2 differs depending on the spiral shape of the scroll casing 4, and the spiral shape of the scroll casing 4 is defined by the opening port diameter of the discharge port 42a, for example. The angle α of the second reference line BL2 is specifically determined by the opening port diameter of the discharge port 42a needed depending on the purpose of the centrifugal fan 1, for example. Therefore, in the centrifugal fan 1 of Embodiment 1, the angle α is described to be 270 degrees, but it may be 300 degrees or other angles depending on the opening port diameter of the discharge port 42a, for example. Similarly, the position of the standard circumferential wall SW having a logarithmic spiral shape is determined by the opening port diameter of the discharge port 42a of the discharge portion 42 in the direction perpendicular to the rotational shaft X.

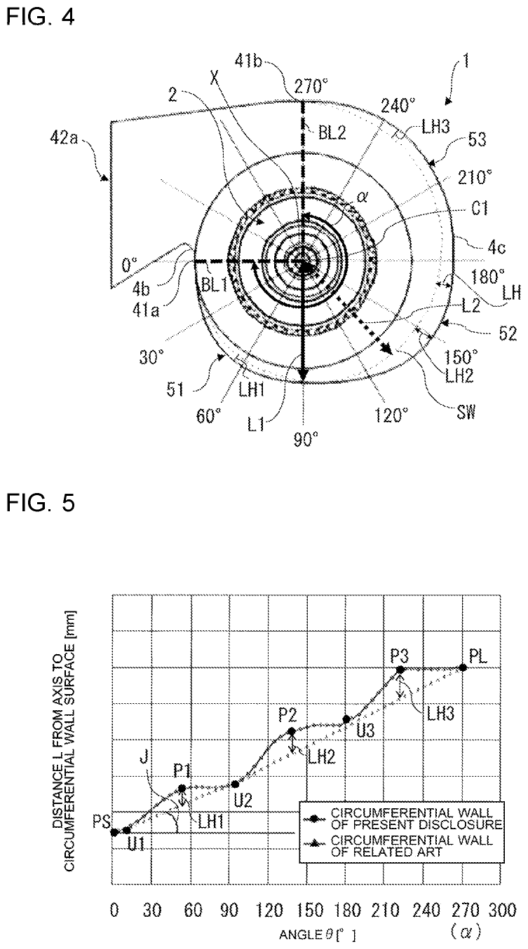

FIG. 4 is a top view illustrating the comparison between the circumferential wall 4c of the centrifugal fan 1 according to Embodiment 1 of the present disclosure and the standard circumferential wall SW of the centrifugal fan of the related art having a logarithmic spiral shape. FIG. 5 shows the relationship between the angle θ [degree] and the distance L [mm] from the axis to the circumferential wall surface in the centrifugal fan 1 or the centrifugal fan of the related art in FIG. 4. In FIG. 5, the solid line connecting the circles shows the circumferential wall 4c, and the broken line connecting the triangles shows the standard circumferential wall SW. The circumferential wall 4c is further described in detail by comparing the centrifugal fan 1 with the centrifugal fan including the standard circumferential wall SW having a logarithmic spiral shape in cross-section perpendicular to the rotational shaft X of the fan 2. The standard circumferential wall SW of the centrifugal fan of the related art shown in FIG. 4 and FIG. 5 forms a curved surface having a spiral shape defined by a predetermined extension rate (predetermined extension rate). Examples of the standard circumferential wall SW having a spiral shape defined by the predetermined extension rate include a standard circumferential wall SW obtained by a logarithmic spiral, a standard circumferential wall SW obtained by an Archimedes' screw, and a standard circumferential wall SW obtained by the involute curve. In a specific example of the centrifugal fan of the related art shown in FIG. 4, the standard circumferential wall SW is defined by a logarithmic spiral, but the standard circumferential wall SW obtained by an Archimedes' screw or the standard circumferential wall SW obtained by an involute curve may be the standard circumferential wall SW of the centrifugal fan of the related art. As shown in FIG. 5, in the circumferential wall having a logarithmic spiral shape forming the centrifugal fan of the related art, an extension rate J defining the standard circumferential wall SW is an angle of the inclination of a graph in which the horizontal axis shows the angle θ being a winding angle, and the vertical axis shows the distance between the axis C1 of the rotational shaft X and the standard circumferential wall SW.

In FIG. 5, a point PS is the position of the first end 41a in the circumferential wall 4c and is a radius of the standard circumferential wall SW of the centrifugal fan of the related art. In FIG. 5, a point PL is the position of the second end 41b in the circumferential wall 4c and is the radius of the standard circumferential wall SW of the centrifugal fan of the related art. As shown in FIG. 4 and FIG. 5, in the circumferential wall 4c, at the first end 41a being the boundary between the circumferential wall 4c and the tongue portion 4b, the distance L1 between the axis C1 of the rotational shaft X and the circumferential wall 4c is equal to the distance L2 between the axis C1 of the rotational shaft X and the standard circumferential wall SW. In the circumferential wall 4c, at the second end 41b being the boundary between the circumferential wall 4c and the discharge portion 42, the distance L1 between the axis C1 of the rotational shaft X and the circumferential wall 4c is equal to the distance L2 between the axis C1 of the rotational shaft X and the standard circumferential wall SW.

As shown in FIG. 4 and FIG. 5, in the circumferential wall 4c, between the first end 41a and the second end 41b of the circumferential wall 4c, the distance L1 between the axis C1 of the rotational shaft X and the circumferential wall 4c is greater than or equal to the distance L2 between the axis C1 of the rotational shaft X and the standard circumferential wall SW. The circumferential wall 4c includes three extended portions between the first end 41a and the second end 41b of the circumferential wall 4c. The three extended portions include maximum points each having a length being the difference LH between the distance L1 between the axis C1 of the rotational shaft X and the circumferential wall 4c and the distance L2 between the axis C1 of the rotational shaft X and the standard circumferential wall SW.

As shown in FIG. 4, the circumferential wall 4c includes a first extended portion 51 bulging out to the radially outer side of the standard circumferential wall SW having a logarithmic spiral shape in a section in which the angle θ is 0 degrees or more and less than 90 degrees. As shown in FIG. 5, the first extended portion 51 includes a first maximum point P1 in a section in which the angle θ is 0 degrees or more and less than 90 degrees. As shown in FIG. 5, the first maximum point P1 is a position in the circumferential wall 4c at which the length of the difference LH1 between the distance L1 between the axis C1 of the rotational shaft X and the circumferential wall 4c and the distance L2 between the axis C1 of the rotational shaft X and the standard circumferential wall SW is the greatest in a section in which the angle θ is 0 degrees or more and less than 90 degrees. As shown in FIG. 4, the circumferential wall 4c includes a second extended portion 52 bulging out to the radially outer side of the standard circumferential wall SW having a logarithmic spiral shape in a section in which the angle θ is 90 degrees or more and less than 180 degrees. As shown in FIG. 5, the second extended portion 52 includes a second maximum point P2 in a section in which the angle θ is 90 degrees or more and less than 180 degrees. As shown in FIG. 5, the second maximum point P2 is a position in the circumferential wall 4c at which the length of a difference LH2 between the distance L1 between the axis C1 of the rotational shaft X and the circumferential wall 4c and the distance L2 between the axis C1 of the rotational shaft X and the standard circumferential wall SW is the greatest in a section in which the angle θ is 90 degrees or more and less than 180 degrees. As shown in FIG. 4, the circumferential wall 4c includes a third extended portion 53 bulging out to the radially outer side of the standard circumferential wall SW having a logarithmic spiral shape in a section in which the angle θ is 180 degrees or more and less than the angle α formed by the second reference line. As shown in FIG. 5, the third extended portion 53 includes a third maximum point P3 in a section in which the angle θ is 180 degrees or more and less than the angle α formed by the second reference line. As shown in FIG. 5, the third maximum point P3 is a position in the circumferential wall 4c at which the length of a difference LH3 between the distance L1 between the axis C1 of the rotational shaft X and the circumferential wall 4c and the distance L2 between the axis C1 of the rotational shaft X and the standard circumferential wall SW is the greatest in a section in which the angle θ is 180 degrees or more and less than the angle α.

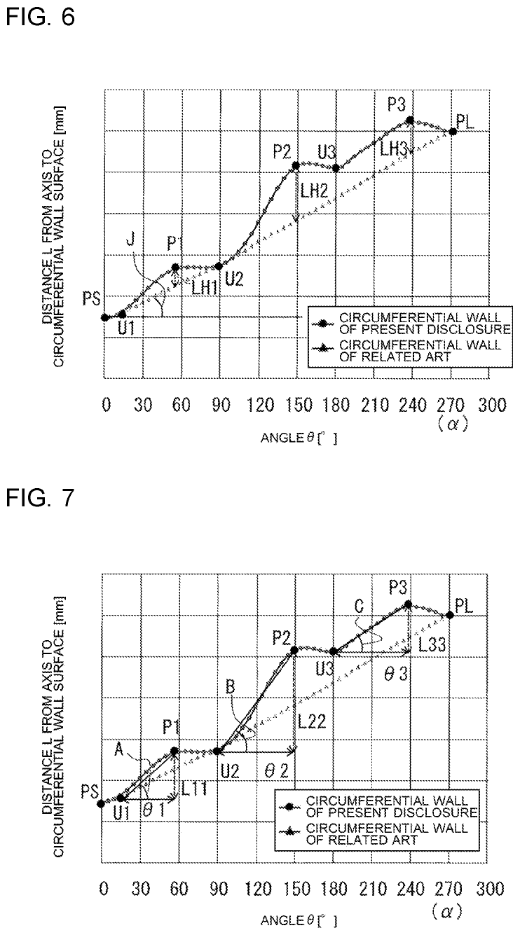

FIG. 6 is a graph obtained by changing the extension rates of the extended portions in the circumferential wall 4c of the centrifugal fan 1 according to Embodiment 1 of the present disclosure. FIG. 7 shows the differences between the extension rates of the extended portions in the circumferential wall 4c of the centrifugal fan 1 according to Embodiment 1 of the present disclosure. As shown in

FIG. 6, the point at which the difference LH is the smallest in a section in which the angle θ is 0 degrees or more and equal to or less than an angle at which the first maximum point P1 is positioned is a first minimum point U1. The point at which the difference LH is the smallest in a section in which the angle θ is 90 degrees or more and equal to or less than an angle at which the second maximum point P2 is positioned is a second minimum point U2. The point at which the difference LH is the smallest in a section in which the angle θ is 180 degrees or more and equal to or less than an angle at which the third maximum point P3 is positioned is a third minimum point U3. In the cases mentioned above, as shown in FIG. 7, a difference L11 between the distance L1 at the first maximum point P1 and the distance L1 at the first minimum point U1 relative to an increase θ1 of the angle θ from the first minimum point U1 to the first maximum point P1 is an extension rate A. A difference L22 between the distance L1 at the second maximum point P2 and the distance L1 at the second minimum point U2 relative to an increase θ2 of the angle θ from the second minimum point U2 to the second maximum point P2 is an extension rate B. A difference L33 between the distance L1 at the third maximum point P3 and the distance L1 at the third minimum point U3 relative to an increase θ3 of the angle θ from the third minimum point U3 to the third maximum point P3 is an extension rate C. At this time, the circumferential wall 4c of the centrifugal fan 1 satisfies a relationship of the extension rate B>the extension rate C, and the extension rate B≥the extension rate A>the extension rate C, or a relationship of the extension rate B>the extension rate C, and the extension rate B>the extension rate C≥the extension rate A.

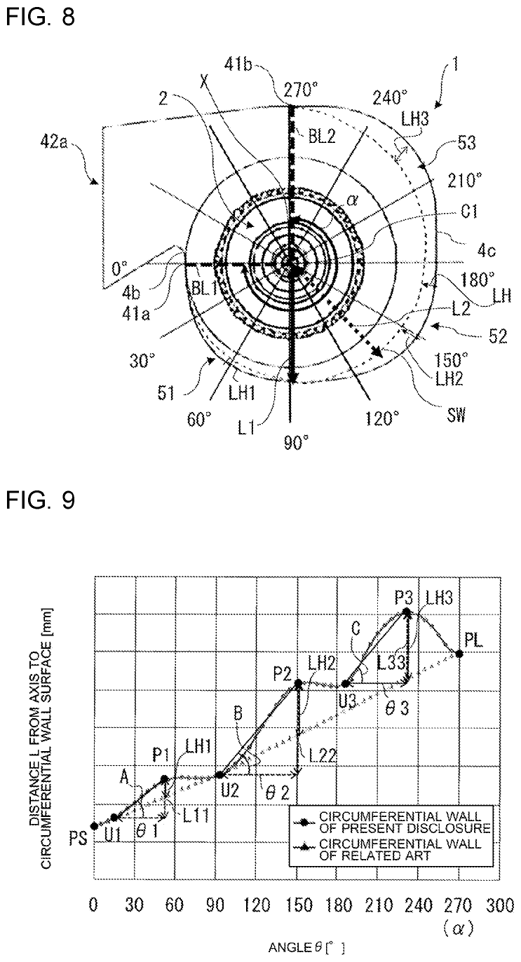

FIG. 8 is a top view illustrating a comparison between the circumferential wall 4c of the centrifugal fan 1 according to Embodiment 1 of the present disclosure having other extension rates, and the standard circumferential wall SW of the centrifugal fan of the related art having a logarithmic spiral shape. FIG. 9 is a graph obtained by changing the other extension rates of the extended portions in the circumferential wall 4c of the centrifugal fan 1 in FIG. 8. As shown in FIG. 9, the point at which the difference LH is the smallest in a section in which the angle θ is 0 degrees or more and equal to or less than an angle at which the first maximum point P1 is positioned is the first minimum point U1. The point at which the difference LH is the smallest in a section in which the angle θ is 90 degrees or more and equal to or less than an angle at which the second maximum point P2 is positioned is the second minimum point U2. The point at which the difference LH is the smallest in a section in which the angle θ is 180 degrees or more and equal to or less than an angle at which the third maximum point P3 is positioned is the third minimum point U3. In the cases above, as shown in FIG. 9, the difference L11 between the distance L1 at the first maximum point P1 and the distance L1 at the first minimum point U1 relative to the increase θ1 of the angle θ from the first minimum point U1 to the first maximum point P1 is the extension rate A. The difference L22 between the distance L1 at the second maximum point P2 and the distance L1 at the second minimum point U2 relative to the increase θ2 of the angle θ from the second minimum point U2 to the second maximum point P2 is the extension rate B. The difference L33 between the distance L1 at the third maximum point P3 and the distance L1 at the third minimum point U3 relative to the increase θ3 of the angle θ from the third minimum point U3 to the third maximum point P3 is the extension rate C. At this time, the circumferential wall 4c of the centrifugal fan 1 satisfies a relationship of the extension rate C>the extension rate B≥the extension rate A.

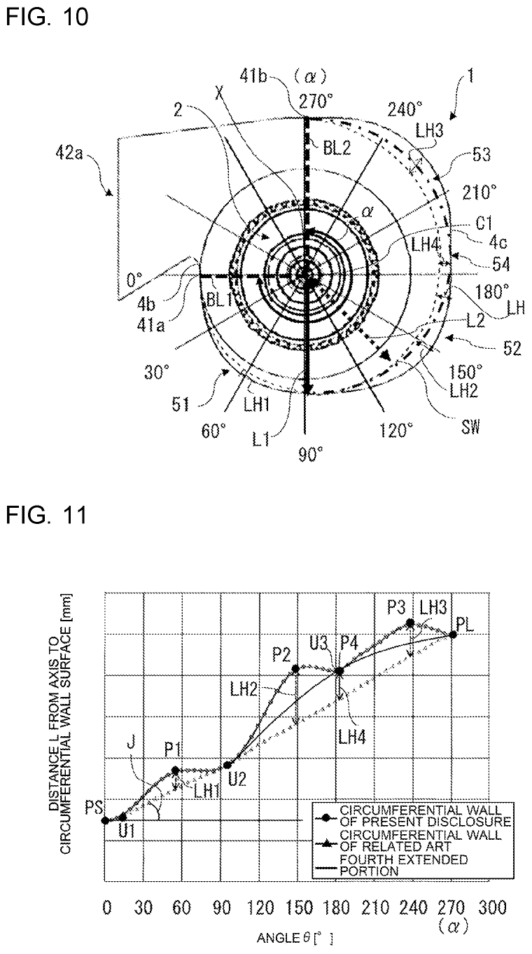

FIG. 10 is a top view illustrating a comparison between the circumferential wall 4c of the centrifugal fan 1 according to Embodiment 1 of the present disclosure having other extension rates and the standard circumferential wall SW of the centrifugal fan of the related art having a logarithmic spiral shape. FIG. 11 is a graph obtained by changing the other extension rates of the extended portions in the circumferential wall 4c of the centrifugal fan 1 in FIG. 10. Note that the one dot chain line shown in FIG. 10 shows the position of a fourth extended portion 54. The centrifugal fan 1 according to Embodiment 1 shown in FIG. 10 includes the fourth extended portion 54 forming the fourth maximum point P4 in a section of the circumferential wall 4c at which the angle θ is 90 degrees to 270 degrees (angle α) being a region opposite to the discharge port 72 of the scroll casing 4. The centrifugal fan 1 according to Embodiment 1 shown in FIG. 10 further includes the second extended portion 52 including the second maximum point P2 and the third extended portion 53 including the third maximum point P3 on the fourth extended portion 54 including the fourth maximum point P4. As shown in FIG. 10, the circumferential wall 4c includes the first extended portion 51 bulging out to the radially outer side of the standard circumferential wall SW having a logarithmic spiral shape in a section in which the angle θ is 0 degrees or more and less than 90 degrees. As shown in FIG. 11, the first extended portion 51 includes the first maximum point P1 in a section in which the angle θ is 0 degrees or more and less than 90 degrees. The first maximum point P1 is a position in the circumferential wall 4c at which the length of the difference LH1 between the distance L1 between the axis C1 of the rotational shaft X and the circumferential wall 4c and the distance L2 between the axis C1 of the rotational shaft X and the standard circumferential wall SW is the greatest in a section in which the angle θ is 0 degrees or more and less than 90 degrees. As shown in FIG. 10, the circumferential wall 4c includes the second extended portion 52 bulging out to the radially outer side of the standard circumferential wall SW having a logarithmic spiral shape in a section in which the angle θ is 90 degrees or more and less than 180 degrees. As shown in FIG. 11, the second extended portion 52 includes the second maximum point P2 in a section in which the angle θ is 90 degrees or more and less than 180 degrees. The second maximum point P2 is a position in the circumferential wall 4c at which the length of the difference LH2 between the distance L1 between the axis C1 of the rotational shaft X and the circumferential wall 4c and the distance L2 between the axis C1 of the rotational shaft X and the standard circumferential wall SW is the greatest in a section in which the angle θ is 90 degrees or more and less than 180 degrees. As shown in FIG. 10, the circumferential wall 4c includes the third extended portion 53 bulging out to the radially outer side of the standard circumferential wall SW having a logarithmic spiral shape in a section in which the angle θ is 180 degrees or more and less than the angle α formed by the second reference line. As shown in FIG. 11, the third extended portion 53 includes the third maximum point P3 in a section in which the angle θ is 180 degrees or more and less than the angle α formed by the second reference line. The third maximum point P3 is a position in the circumferential wall 4c at which the length of the difference LH3 between the distance L1 between the axis C1 of the rotational shaft X and the circumferential wall 4c and the distance L2 between the axis C1 of the rotational shaft X and the standard circumferential wall SW is the greatest in a section in which the angle θ is 180 degrees or more and less than the angle α. As shown in FIG. 10, the circumferential wall 4c includes the fourth extended portion 54 bulging out to the radially outer side of the standard circumferential wall SW having a logarithmic spiral shape in a section in which the angle θ is 90 degrees or more and less than the angle α formed by the second reference line. As shown in FIG. 11, the fourth extended portion 54 includes the fourth maximum point P4 in a section in which the angle θ is 90 degrees or more and less than the angle α formed by the second reference line. The fourth maximum point P4 is a position in the circumferential wall 4c at which the length of the difference LH4 between the distance L1 between the axis C1 of the rotational shaft X and the circumferential wall 4c and the distance L2 between the axis C1 of the rotational shaft X and the standard circumferential wall SW is the greatest in a section in which the angle θ is 90 degrees or more and less than the angle α. The centrifugal fan 1 further includes the second extended portion 52 including the second maximum point P2 and the third extended portion 53 including the third maximum point P3 on the fourth extended portion 54 including the fourth maximum point P4. Therefore, in the circumferential wall 4c forming a region from the second extended portion 52 to the third extended portion 53, the distance L1 between the axis C1 of the rotational shaft X and the circumferential wall 4c is greater than the distance L2 between the axis C1 of the rotational shaft X and the standard circumferential wall SW.

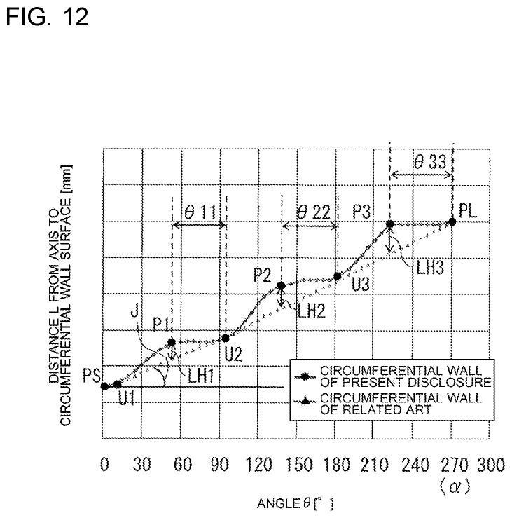

FIG. 12 is a graph showing other extension rates in the circumferential wall 4c of the centrifugal fan 1 according to Embodiment 1 in FIG. 5. FIG. 12 shows a more-desirable shape of the circumferential wall 4c with reference to FIG. 5. A difference L44 (not shown) between the distance L1 at the second minimum point U2 and the distance L1 at the first maximum point P1 relative to an increase θ11 of the angle θ from the first maximum point P1 to the second minimum point U2 is an extension rate D. A difference L55 (not shown) between the distance L1 at the third minimum point U3 and the distance L1 at the second maximum point P2 relative to an increase θ22 of the angle θ from the second maximum point P2 to the third minimum point U3 is an extension rate E. A difference L66 (not shown) between the distance L1 at the angle α and the distance L1 at the third maximum point P3 relative to an increase θ33 of the angle θ from the third maximum point P3 to the angle α is an extension rate F. The distance L2 between the axis C1 of the rotational shaft X and the standard circumferential wall SW relative to the increase of the angle θ is an extension rate J. In the cases above, in the circumferential wall 4c of the centrifugal fan 1, the extension rate J>the extension rate D≥0, the extension rate J>the extension rate E≥0, and the extension rate J>the extension rate F≥0 are desired to be satisfied. Note that, although the circumferential wall 4c is desired to have a shape having the extension rates described with reference to FIG. 12, the circumferential wall 4c does not necessarily need to have a shape having the extension rates described with reference to FIG. 12. The circumferential wall 4c having a structure with the extension rates shown in FIG. 12 may be combined with the circumferential wall 4c having a structure with the extension rates shown in FIG. 6, the circumferential wall 4c having a structure with the extension rates shown in FIG. 9, and the circumferential wall 4c having a structure with the extension rates shown in FIG. 11.

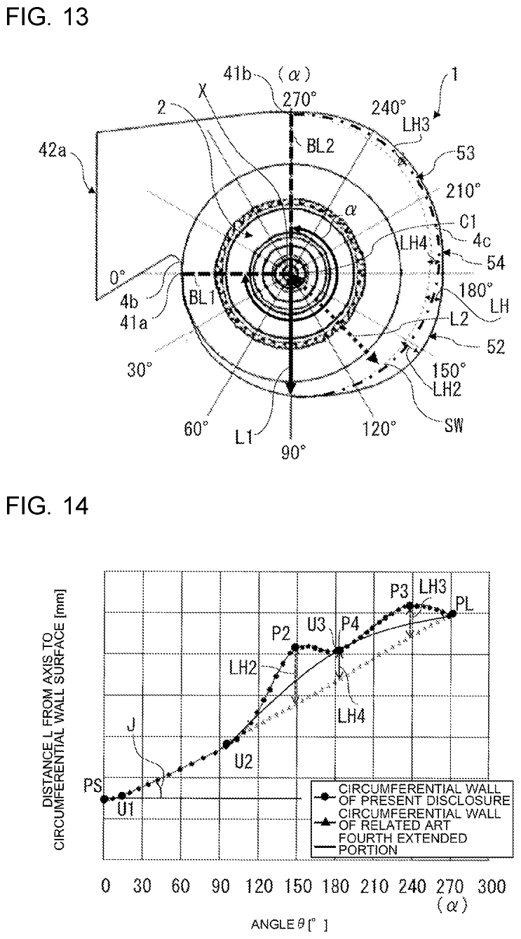

FIG. 13 is a top view illustrating a comparison between the circumferential wall 4c of the centrifugal fan 1 according to Embodiment 1 of the present disclosure having other extension rates and the standard circumferential wall SW of the centrifugal fan of the related art having a logarithmic spiral shape. FIG. 14 is a graph obtained by changing the other extension rates of the extended portions in the circumferential wall 4c of the centrifugal fan 1 in FIG. 13. Note that the one dot chain line shown in FIG. 13 shows the position of the fourth extended portion 54. The centrifugal fan 1 according to Embodiment 1 shown in FIG. 13 includes the fourth extended portion 54 forming the fourth maximum point P4 in a section of the circumferential wall 4c at which the angle θ is 90 degrees to 270 degrees (angle α) being a region opposite to the discharge port 72 of the scroll casing 4. The centrifugal fan 1 according to Embodiment 1 shown in FIG. 13 further includes the second extended portion 52 including the second maximum point P2 and the third extended portion 53 including the third maximum point P3 on the fourth extended portion 54 including the fourth maximum point P4. As shown in FIG. 13, the circumferential wall 4c has a circumferential wall along the standard circumferential wall SW having a logarithmic spiral shape in a section in which the angle θ is 0 degrees or more and less than 90 degrees. In other words, in the circumferential wall 4c, the distance L1 between the axis C1 of the rotational shaft X and the circumferential wall 4c is equal to the distance L2 between the axis C1 of the rotational shaft X and the standard circumferential wall SW in a section in which the angle θ is 0 degrees or more and less than 90 degrees. As shown in FIG. 13, the circumferential wall 4c includes the second extended portion 52 bulging out to the radially outer side of the standard circumferential wall SW having a logarithmic spiral shape in a section in which the angle θ is 90 degrees or more and less than 180 degrees. As shown in FIG. 14, the second extended portion 52 includes the second maximum point P2 in a section in which the angle θ is 90 degrees or more and less than 180 degrees. The second maximum point P2 is a position in the circumferential wall 4c at which the length of the difference LH2 between the distance L1 between the axis C1 of the rotational shaft X and the circumferential wall 4c and the distance L2 between the axis C1 of the rotational shaft X and the standard circumferential wall SW is the greatest in a section in which the angle θ is 90 degrees or more and less than 180 degrees. As shown in FIG. 13, the circumferential wall 4c includes the third extended portion 53 bulging out to the radially outer side of the standard circumferential wall SW having a logarithmic spiral shape in a section in which the angle θ is 180 degrees or more and less than the angle α formed by the second reference line. As shown in FIG. 14, the third extended portion 53 includes the third maximum point P3 in a section in which the angle θ is 180 degrees or more and less than the angle α formed by the second reference line. The third maximum point P3 is a position in the circumferential wall 4c at which the length of the difference LH3 between the distance L1 between the axis C1 of the rotational shaft X and the circumferential wall 4c and the distance L2 between the axis C1 of the rotational shaft X and the standard circumferential wall SW is the greatest in a section in which the angle θ is 180 degrees or more and less than the angle α. As shown in FIG. 13, the circumferential wall 4c includes the fourth extended portion 54 bulging out to the radially outer side of the standard circumferential wall SW having a logarithmic spiral shape in a section in which the angle θ is 90 degrees or more and less than the angle α formed by the second reference line. As shown in FIG. 14, the fourth extended portion 54 includes the fourth maximum point P4 in a section in which the angle θ is 90 degrees or more and less than the angle α formed by the second reference line.

The fourth maximum point P4 is a position in the circumferential wall 4c at which the length of the difference LH4 between the distance L1 between the axis C1 of the rotational shaft X and the circumferential wall 4c and the distance L2 between the axis C1 of the rotational shaft X and the standard circumferential wall SW is the greatest in a section in which the angle θ is 90 degrees or more and less than the angle α. The centrifugal fan 1 further includes the second extended portion 52 including the second maximum point P2 and the third extended portion 53 including the third maximum point P3 on the fourth extended portion 54 including the fourth maximum point P4. Therefore, in the circumferential wall 4c forming the region from the second extended portion 52 to the third extended portion 53, the distance L1 between the axis C1 of the rotational shaft X and the circumferential wall 4c is greater than the distance L2 between the axis C1 of the rotational shaft X and the standard circumferential wall SW.

### (Tongue Portion 4b)

The tongue portion 4b guides the air flow generated by the fan 2 to the discharge port 42a via the scroll portion 41. The tongue portion 4b is a protruding portion provided in a boundary portion between the scroll portion 41 and the discharge portion 42. The tongue portion 4b extends in a direction parallel to the rotational shaft X in the scroll casing 4.

### Operation of Centrifugal Fan 1

When the fan 2 rotates, the air outside the scroll casing 4 is suctioned into the scroll casing 4 through the suction ports 5. The air suctioned into the scroll casing 4 is suctioned by the fan 2 by being guided by the bell mouths 3. In the process in which the air suctioned by the fan 2 passes through the plurality of blades 2d, the air suctioned by the fan 2 is turned to be an air flow to which the dynamic pressure and the static pressure are applied and is blown out toward the radially outer side of the fan 2. In the air flow blown out from the fan 2, the dynamic pressure is converted to the static pressure while the air flow is guided between the inner side of the circumferential wall 4c and the blades 2d in the scroll portion 41. The air flow passes through the scroll portion 41, and then is blown out to the outside of the scroll casing 4 from the discharge port 42a formed at the discharge portion 42.

As described above, in the centrifugal fan 1 according to Embodiment 1, the distance L1 is equal to the distance L2 at the first end 41a and the second end 41b in the circumferential wall 4c in comparison with the centrifugal fan including the standard circumferential wall SW having a logarithmic spiral shape in cross-section perpendicular to the rotational shaft X of the fan 2. In the circumferential wall 4c, between the first end 41a and the second end 41b of the circumferential wall 4c, the distance L1 is greater than or equal to the distance L2. The circumferential wall 4c includes the plurality of extended portions between the first end 41a and the second end 41b of the circumferential wall 4c. The plurality of extended portions include maximum points each having a length being the difference LH between the distance L1 and the distance L2. In the centrifugal fan 1, the dynamic pressure is increased when the distance between the fan 2 and the wall surface of the circumferential wall 4c is the smallest near the tongue portion 4b. To recover the pressure from the dynamic pressure to the static pressure, the dynamic pressure is converted to the static pressure by reducing the speed by gradually extending the distance between the fan 2 and the wall surface of the circumferential wall 4c in the flow direction of the air flow. At this time, ideally, the amount of pressure recovery can be increased and the air-sending efficiency can be increased as the distance for which the air flow flows along the circumferential wall 4c increases. In other words, a configuration in which the maximum pressure recovery can be obtained is obtained when the configuration includes the circumferential wall 4c having extension rates greater than or equal to the extension rates of a normal logarithmic spiral shape (involute curve), and when the circumferential wall 4c of the scroll portion 41 is configured to have extension rates set within the range in which the separation of the air flow due to sudden extension such as an extension causing the air flow to be bent at almost a right angle does not occur, for example. The centrifugal fan 1 according to Embodiment 1 further includes a plurality of extended portions from a uniform logarithmic spiral shape (involute curve), and can extend the distance of the air passage in the scroll portion 41. As a result, the centrifugal fan 1 can convert the dynamic pressure to the static pressure by reducing the speed of the air flow flowing in the scroll casing 4 while preventing the separation of the air flow, and hence can improve the air-sending efficiency while reducing the noise. The centrifugal fan 1 can increase the distance of the air passage in which the distance between the axis C1 of the rotational shaft X and the circumferential wall 4c is extended by including the abovementioned configuration in the direction in which the circumferential wall 4c can be extended even when the extension rate of the circumferential wall 4c of the scroll casing to a predetermined direction cannot be sufficiently secured due to a restriction in the external dimensions depending on the place of installation. As a result, the centrifugal fan 1 can improve the air-sending efficiency while reducing the noise because the centrifugal fan 1 can convert the dynamic pressure to the static pressure by reducing the speed of the air flow flowing in the scroll casing 4 while preventing the separation of the air flow even when the extension rate of the circumferential wall 4c of the scroll casing to a predetermined direction cannot be sufficiently secured.

In the centrifugal fan 1, the three extended portions includes the first maximum point P1 in a section in which the angle θ is 0 degrees or more and less than 90 degrees, the second maximum point P2 in a section in which the angle θ is 90 degrees or more and less than 180 degrees, and the third maximum point P3 in a section in which the angle θ is 180 degrees or more and less than the angle α formed by the second reference line. The present disclosure further includes extended portions having three maximum points in addition to a uniform logarithmic spiral shape (involute curve), and hence can extend the distance of the air passage in the scroll portion 41. When the extension rates of the logarithmic spiral shape (involute curve) of the related art are set as the standard, a case of the extended portions including three maximum points always has the highest extension rates as compared to a case of the extended portions including two maximum points because the configuration thereof is included in the extended portions including three maximum points. Therefore, as compared to the centrifugal fan including the standard circumferential wall SW having a logarithmic spiral shape of the related art, the centrifugal fan 1 satisfying the relationship can extend the distance between the axis C1 of the rotational shaft X and the circumferential wall 4c and extend the distance of the air passage while preventing the separation of the air flow. For example, when a device (for example, an air-conditioning apparatus) in which the centrifugal fan 1 is installed has a restriction in external dimensions due to its low profile or the like, there may be a case where the distance between the axis C1 of the rotational shaft X and the circumferential wall 4c of the centrifugal fan 1 cannot be extended in the direction in which the angle θ is 270 degrees or the direction in which the angle θ is 90 degrees. The centrifugal fan 1 includes three maximum points in a section in which the angle θ is within the abovementioned range, and hence can increase the distance of the air passage in which the distance between the axis C1 of the rotational shaft X and the circumferential wall 4c is extended even when the device in which the centrifugal fan 1 is installed has a restriction in external dimensions due to its low profile or the like. As a result, the centrifugal fan 1 can convert the dynamic pressure to the static pressure by reducing the speed of the air flow flowing in the scroll casing 4 while preventing the separation of the air flow, and hence can improve the air-sending efficiency while reducing the noise.

In the centrifugal fan 1, the extension rates of the three extended portions of the circumferential wall 4c satisfy a relationship of the extension rate B>the extension rate C, and the extension rate B≥the extension rate A>the extension rate C, or a relationship of the extension rate B>the extension rate C, and the extension rate B>the extension rate C≥the extension rate A. The scroll portion 41 also has a function of raising the dynamic pressure in a region in which the angle θ is 0 degrees to 90 degrees, and hence the static pressure conversion can be increased more when the extension rates of a region in which the angle θ is 90 degrees to 180 degrees are increased as compared to increasing the extension rates of the region above. Therefore, as compared to the centrifugal fan including the standard circumferential wall SW having a logarithmic spiral shape of the related art, the centrifugal fan 1 satisfying the relationship can extend the distance between the axis C1 of the rotational shaft X and the circumferential wall 4c and extend the distance of the air passage while preventing the separation of the air flow in a region with excellent static pressure conversion efficiency. As a result, the centrifugal fan 1 can convert the dynamic pressure to the static pressure by reducing the speed of the air flow flowing in the scroll casing 4 while preventing the separation of the air flow, and hence can improve the air-sending efficiency while reducing the noise. When a device (for example, an air-conditioning apparatus) in which the centrifugal fan 1 is installed has a restriction in external dimensions due to its low profile or the like, there may be a case where the distance between the axis C1 of the rotational shaft X and the circumferential wall 4c of the centrifugal fan 1 cannot be extended in the direction in which the angle θ is 270 degrees or the direction in which the angle θ is 90 degrees. The centrifugal fan 1 includes the abovementioned extension rates, and hence can increase the distance of the air passage in which the distance between the axis C1 of the rotational shaft X and the circumferential wall 4c is extended even when the device in which the centrifugal fan 1 is installed has a restriction in external dimensions due to its low profile or the like. As a result, the centrifugal fan 1 can convert the dynamic pressure to the static pressure by reducing the speed of the air flow flowing in the scroll casing 4 while preventing the separation of the air flow, and hence can improve the air-sending efficiency while reducing the noise.

In the centrifugal fan 1, the extension rates of the three extended portions of the circumferential wall 4c satisfy a relationship of the extension rate C>the extension rate B≥the extension rate A. The scroll portion 41 also has a function of raising the dynamic pressure in a region in which the angle θ is 0 degrees to 90 degrees, and hence the static pressure conversion can be increased when the extension rates of a region in which the angle θ is 90 degrees to 180 degrees are increased as compared to raising the extension rates of the region above. However, a part of the function of the scroll portion 41 for raising the dynamic pressure also remains in the region in which the angle θ is 90 degrees to 180 degrees. Therefore, the air-sending efficiency further increases when the extension rate is increased in a region in which the angle θ is 180 degrees to 270 degrees as compared to when the extension rate is increased in the region in which the angle θ is 90 degrees to 180 degrees. In the region (the angle θ is 180 degrees to 270 degrees) in which the distance between the fan 2 and the circumferential wall 4c is the farthest, the function of the scroll portion 41 for raising the dynamic pressure is almost lost. Therefore, the air-sending efficiency can be maximized by maximizing the extension rate of the scroll portion 41 in that region. As a result, the centrifugal fan 1 can improve the air-sending efficiency while reducing the noise.

In the centrifugal fan 1, the plurality of extended portions include the first extended portion 51 including the first maximum point P1 in a section in which the angle θ is 0 degrees or more and less than 90 degrees, the second extended portion 52 including the second maximum point P2 in a section in which the angle θ is 90 degrees or more and less than 180 degrees, and the third extended portion 53 including the third maximum point P3 in a section in which the angle θ is 180 degrees or more and less than the angle α formed by the second reference line. In the circumferential wall 4c forming the region from the second extended portion 52 to the third extended portion 53, the distance L1 between the axis C1 of the rotational shaft X and the circumferential wall 4c is greater than the distance L2 between the axis C1 of the rotational shaft X and the standard circumferential wall SW. The centrifugal fan 1 has a configuration in which the scroll bulges out to the opposite side of the discharge port 72, and hence can extend the distance of the wall surface of the scroll along the flow of the air flow by the effect of the three extended portions and the bulged-out scroll. As a result, the centrifugal fan 1 can convert the dynamic pressure to the static pressure by reducing the speed of the air flow flowing in the scroll casing 4 while preventing the separation of the air flow, and hence can improve the air-sending efficiency while reducing the noise.

In the centrifugal fan 1, the plurality of extended portions include the second extended portion 52 including the second maximum point P2 in a section in which the angle θ is 90 degrees or more and less than 180 degrees, and the third extended portion 53 including the third maximum point P3 in a section in which the angle θ is 180 degrees or more and less than the angle α formed by the second reference line. In the circumferential wall 4c forming the region from the second extended portion 52 to the third extended portion 53, the distance L1 between the axis C1 of the rotational shaft X and the circumferential wall 4c is greater than the distance L2 between the axis C1 of the rotational shaft X and the standard circumferential wall SW. The centrifugal fan 1 has a configuration in which the scroll bulges out to the side opposite to the discharge port 72, and hence can extend the distance of the wall surface of the scroll along the flow of the air flow by the effect of the two extended portions and the bulged-out scroll. As a result, the centrifugal fan 1 can convert the dynamic pressure to the static pressure by reducing the speed of the air flow flowing in the scroll casing 4 while preventing the separation of the air flow, and hence can improve the air-sending efficiency while reducing the noise.

In the centrifugal fan 1, the circumferential wall 4c of the centrifugal fan 1 is desired to satisfy the extension rate J>the extension rate D≥0, the extension rate J>the extension rate E≥0, and the extension rate J>the extension rate F≥0. Because the circumferential wall 4c of the centrifugal fan 1 has the abovementioned extension rates, the air passage between the rotational shaft X and the circumferential wall 4c does not narrow, a pressure loss of the air flow generated by the fan 2 is not generated. As a result, the centrifugal fan 1 can reduce the speed and convert the dynamic pressure to the static pressure, and can improve the air-sending efficiency while reducing the noise.

### Embodiment 2

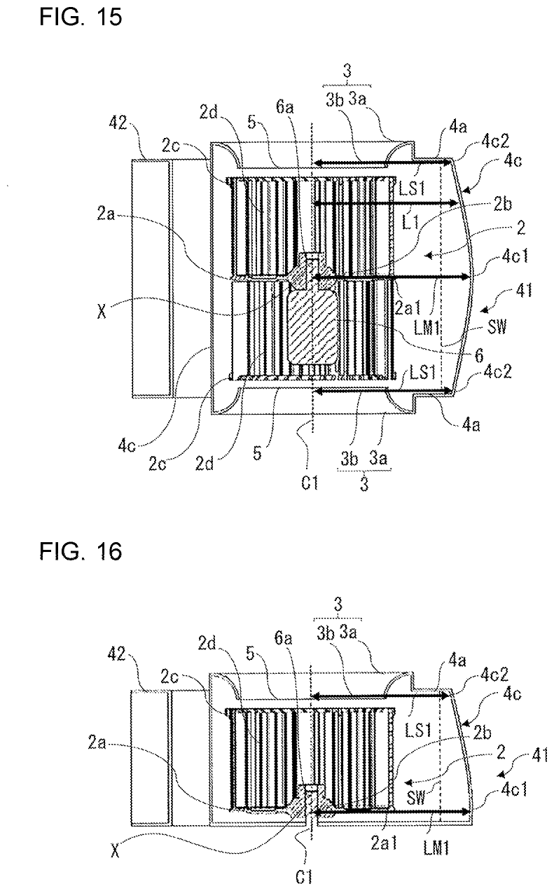

FIG. 15 is a cross-sectional view of a centrifugal fan 1 according to Embodiment 2 of the present disclosure 1 taken along the axis direction. The dotted line shown in FIG. 15 shows the position of the standard circumferential wall SW of the centrifugal fan having a logarithmic spiral shape being a related-art example. Note that sections having the same configurations as the centrifugal fan 1 in FIG. 1 to FIG. 14 are denoted by the same reference characters, and descriptions thereof are omitted. The centrifugal fan 1 of Embodiment 2 is the centrifugal fan 1 including the double-suction scroll casing 4 having the side walls 4a in which the suction ports 5 are formed on both sides of the main plate 2a in the axis direction of the rotational shaft X. As shown in FIG. 15, in the centrifugal fan 1 of Embodiment 2, the circumferential wall 4c extends more to the radial direction of the rotational shaft X as the circumferential wall 4c is farther away from the suction ports 5 in the axis direction of the rotational shaft X. In other words, in the centrifugal fan 1 of Embodiment 2, in the axis direction of the rotational shaft X, the distance between the axis C1 of the rotational shaft X and the inner wall surface of the circumferential wall 4c increases as the circumferential wall 4c is farther away from the suction ports 5. In the circumferential wall 4c of the centrifugal fan 1, the distance L1 between the axis C1 of the rotational shaft X and the inner wall surface of the circumferential wall 4c is the greatest at a position 4c1 facing the circumferential portion 2a1 of the main plate 2a in the direction parallel to the axis direction of the rotational shaft X. A distance LM1 shown in FIG. 15 shows a portion at which the distance L1 between the axis C1 of the rotational shaft X and the inner wall surface of the circumferential wall 4c is the greatest in the direction parallel to the axis direction of the rotational shaft X at the position 4c1 in the circumferential wall 4c facing the circumferential portion 2a1 of the main plate 2a. In the circumferential wall 4c of the centrifugal fan 1, the distance L1 between the axis C1 of the rotational shaft X and the inner wall surface of the circumferential wall 4c is the smallest at positions 4c2 being boundaries with the side walls 4a in the direction parallel to the axis direction of the rotational shaft X. Each of distances LS1 shown in FIG. 15 shows a portion at which the distance L1 between the axis C1 of the rotational shaft X and the inner wall surface of the circumferential wall 4c is the smallest in the direction parallel to the axis direction of the rotational shaft X at the position 4c2 being the boundary between the circumferential wall 4c and the side wall 4a. The circumferential wall 4c bulges out at the position 4c1 facing the circumferential portion 2a1 of the main plate 2a in the direction parallel to the rotational shaft X, and the distance L1 is the greatest at the position 4c1 facing the circumferential portion 2a1 of the main plate 2a in the direction parallel to the rotational shaft X. In other words, in the centrifugal fan 1 of Embodiment 2, the circumferential wall 4c is formed in an arc shape, so that the distance L1 between the axis C1 of the rotational shaft X and the inner wall surface of the circumferential wall 4c is the greatest at a position facing the circumferential portion 2a1 of the main plate 2a in a cross-sectional view parallel to the rotational shaft X. Note that, in the circumferential wall 4c in cross-section, the circumferential wall 4c only needs to be formed in a convex shape, so that the distance L1 between the axis C1 of the rotational shaft X and the inner wall surface of the circumferential wall 4c is the greatest at the position 4c1 facing the circumferential portion 2a1 of the main plate 2a, and may include a linear portion in a part or the entirety thereof in cross-section.

FIG. 16 is a cross-sectional view of a modified example of the centrifugal fan 1 according to Embodiment 2 of the present disclosure taken along the axis direction. The dotted line shown in FIG. 16 shows the position of the standard circumferential wall SW of the centrifugal fan of the related-art example having a logarithmic spiral shape. Note that sections having the same configurations as the centrifugal fan 1 in FIG. 1 to FIG. 14 are denoted by the same reference characters, and descriptions thereof are omitted. The modified example of the centrifugal fan 1 of Embodiment 2 is the centrifugal fan 1 including the single-suction scroll casing 4 having the side wall 4a in which the suction port 5 is formed on one side of the main plate 2a in the axis direction of the rotational shaft X. As shown in FIG. 16, in the modified example of the centrifugal fan 1 of Embodiment 2, the circumferential wall 4c extends more to the radial direction of the rotational shaft X as the circumferential wall 4c is farther away from the suction port 5 in the axis direction of the rotational shaft X. In other words, in the centrifugal fan 1 of Embodiment 2, the distance between the axis C1 of the rotational shaft X and the inner wall surface of the circumferential wall 4c increases as the circumferential wall 4c is farther away from the suction ports 5 in the axis direction of the rotational shaft X. In the circumferential wall 4c of the centrifugal fan 1, the distance L1 between the axis C1 of the rotational shaft X and the inner wall surface of the circumferential wall 4c is the greatest at the position 4c1 facing the circumferential portion 2a1 of the main plate 2a in the direction parallel to the axis direction of the rotational shaft X. The distance LM1 shown in FIG. 16 shows a portion at which the distance L1 between the axis C1 of the rotational shaft X and the inner wall surface of the circumferential wall 4c is the greatest in the direction parallel to the axis direction of the rotational shaft X at the position 4c1 in the circumferential wall 4c facing the circumferential portion 2a1 of the main plate 2a. In the circumferential wall 4c of the centrifugal fan 1, the distance L1 between the axis C1 of the rotational shaft X and the inner wall surface of the circumferential wall 4c is the smallest at the position 4c2 being a boundary with the side wall 4a in the direction parallel to the axis direction of the rotational shaft X. The distance LS1 shown in FIG. 16 shows a portion at which the distance L1 between the axis C1 of the rotational shaft X and the inner wall surface of the circumferential wall 4c is the smallest in the direction parallel to the axis direction of the rotational shaft X at the position 4c2 being the boundary between the circumferential wall 4c and the side wall 4a. The circumferential wall 4c bulges out at the position 4c1 facing the circumferential portion 2a1 of the main plate 2a in the direction parallel to the rotational shaft X, and the distance L1 is the greatest at the position 4c1 facing the circumferential portion 2a1 of the main plate 2a in the direction parallel to the rotational shaft X. In other words, in the centrifugal fan 1 of Embodiment 2, the circumferential wall 4c is formed in a curved shape, so that the distance L1 between the axis C1 of the rotational shaft X and the inner wall surface of the circumferential wall 4c is the greatest at a position facing the circumferential portion 2a1 of the main plate 2a in a cross-sectional view parallel to the rotational shaft X. Note that the circumferential wall 4c in cross-section only needs to be formed in a convex shape in which the distance L1 between the axis C1 of the rotational shaft X and the inner wall surface of the circumferential wall 4c is the greatest at the position 4c1 facing the circumferential portion 2a1 of the main plate 2a, and may include a linear portion in a part or the entirety thereof in cross-section.

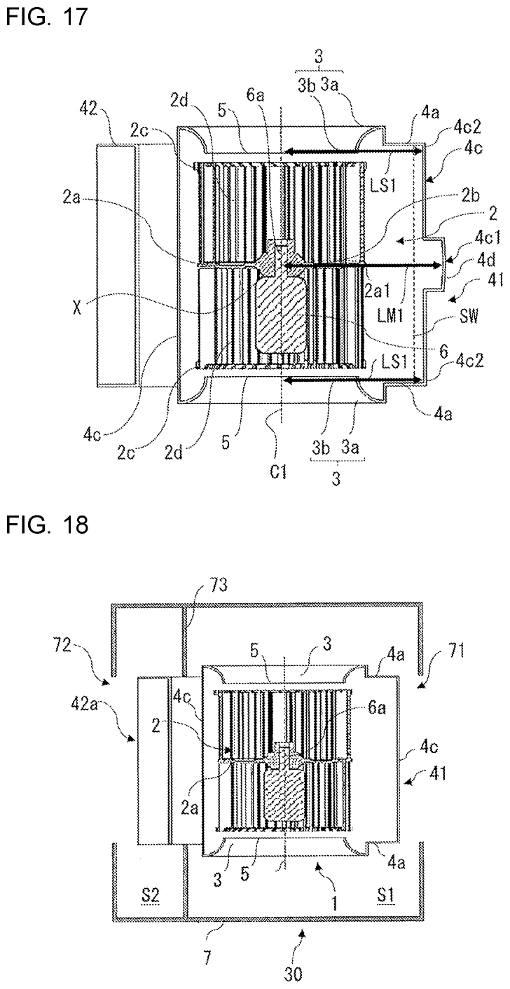

FIG. 17 is a cross-sectional view of another modified example of the centrifugal fan 1 according to Embodiment 2 of the present disclosure taken along the axis direction. The dotted line shown in FIG. 17 shows the position of the standard circumferential wall SW of the centrifugal fan of the related-art example having a logarithmic spiral shape. Note that sections having the same configurations as the centrifugal fan 1 in FIG. 1 to FIG. 14 are denoted by the same reference characters, and descriptions thereof are omitted. The other modified example of the centrifugal fan 1 of Embodiment 2 is the centrifugal fan 1 including the double-suction scroll casing 4 having the side walls 4a in which the suction ports 5 are formed on both sides of the main plate 2a in the axis direction of the rotational shaft X. As shown in FIG. 17, the circumferential wall 4c of the centrifugal fan 1 of Embodiment 2 has a protruding portion 4d at which a part of the circumferential wall 4c protrudes in the radial direction of the rotational shaft X at the position 4c1 facing the circumferential portion 2a1 of the main plate 2a in the axis direction of the rotational shaft X. The protruding portion 4d is a portion in a part of the circumferential wall 4c at which the distance between the axis C1 of the rotational shaft X and the inner wall surface of the circumferential wall 4c increases in the axis direction of the rotational shaft X. The protruding portion 4d is formed on a portion of the circumferential wall 4c between the first end 41a and the second end 41b in a longitudinal direction thereof. Note that, on a portion of the circumferential wall 4c between the first end 41a and the second end 41b, the protruding portion 4d may be formed in the entire range from the first end 41a to the second end 41b or in only a part of the range. The circumferential wall 4c has the protruding portion 4d protruding to the radial direction of the rotational shaft X in the circumferential direction of the rotational shaft X. In the circumferential wall 4c of the centrifugal fan 1, the distance L1 between the axis C1 of the rotational shaft X and the inner wall surface of the circumferential wall 4c is the greatest at the position 4c1 facing the circumferential portion 2a1 of the main plate 2a in the direction parallel to the axis direction of the rotational shaft X. In other words, in the circumferential wall 4c of the centrifugal fan 1, the distance L1 between the axis C1 of the rotational shaft X and the inner wall surface of the circumferential wall 4c is the greatest at the protruding portion 4d in the direction parallel to the axis direction of the rotational shaft X. The distance LM1 shown in FIG. 17 shows a portion at which the distance L1 between the axis C1 of the rotational shaft X and the inner wall surface of the circumferential wall 4c is the greatest in the direction parallel to the axis direction of the rotational shaft X at the position 4c1 in the circumferential wall 4c facing the circumferential portion 2a1 of the main plate 2a. In the circumferential wall 4c of the centrifugal fan 1, the distance L1 between the axis C1 of the rotational shaft X and the inner wall surface of the circumferential wall 4c is the smallest at the positions 4c2 being boundaries with the side walls 4a in the direction parallel to the axis direction of the rotational shaft X. Each of the distances LS1 shown in FIG. 17 shows a portion at which the distance L1 between the axis C1 of the rotational shaft X and the inner wall surface of the circumferential wall 4c is the smallest in the direction parallel to the axis direction of the rotational shaft X at the position 4c2 being the boundary between the circumferential wall 4c and the side wall 4a. As shown in FIG. 17, in the circumferential wall 4c, the distance LS1 between the axis C1 of the rotational shaft X and the inner wall surface of the circumferential wall 4c is fixed in the axis direction of the rotational shaft X. Note that the protruding portion 4d is formed in a rectangular shape made of linear portions in cross-section, but may be formed in an arc shape made of curved portions, for example, or may be other shapes having a linear portion and a curved portion. The circumferential wall 4c is not limited to have a configuration in which the distance LS1 between the axis C1 of the rotational shaft X and the inner wall surface of the circumferential wall 4c is fixed in the axis direction of the rotational shaft X. In the circumferential wall 4c, the distance L1 between the axis C1 of the rotational shaft X and the inner wall surface of the circumferential wall 4c may be extended from the side walls 4a to the protruding portion 4d, for example.

The centrifugal fan including the standard circumferential wall SW having a logarithmic spiral shape being the related-art example, has the following features regarding the air flow flowing in the air passage in the portion at a position 4c1 or the position 4c2 in the circumferential wall 4c in the direction parallel to the axis direction of the rotational shaft X. In the centrifugal fan of the related art, the speed of the air flow is fast and the dynamic pressure is high in the air passage between the circumferential wall 4c at the position 4c1 and the rotational shaft X. In the centrifugal fan of the related art, the speed of the air flow is slow and the dynamic pressure is low in the air passage between the circumferential wall 4c at the position 4c2 and the rotational shaft X. Therefore, in the centrifugal fan of the related art, a case where the air flow does not flow along the inner peripheral surface of the circumferential wall 4c may tend to occur as the air flow flows from the center portion of the circumferential wall 4c to the suction end in the direction parallel to the axis direction of the rotational shaft X. Meanwhile, in the centrifugal fan 1 of Embodiment 2 and the centrifugal fans 1 of the modified examples, the distance L1 between the axis C1 of the rotational shaft X and the inner wall surface of the circumferential wall 4c is the greatest at the position 4c1 in the circumferential wall 4c facing the circumferential portion 2a1 of the main plate 2a when seen from the direction parallel to the rotational shaft X. Therefore, the air flow tends to be collected in the air passage at a portion of the circumferential wall 4c at the position 4c1 at which the speed of the air flow is fast and the dynamic pressure is high along the circumferential wall 4c in cross-section, and a portion at which the speed of the air flow is slow and the dynamic pressure is low can be reduced in the air passage. As a result, in the centrifugal fans 1 of Embodiment 2 and the modified examples, the air flow can be efficiently caused to flow along the inner peripheral surface of the circumferential wall 4c.

As described above, in the centrifugal fan 1 according to Embodiment 2 and the modified examples, the distance L1 between the axis C1 of the rotational shaft X and the inner wall surface of the circumferential wall 4c is the greatest at the position 4c1 in the circumferential wall 4c facing the circumferential portion 2a1 of the main plate 2a when seen from the direction parallel to the rotational shaft X. Therefore, in the circumferential wall 4c in cross-section parallel to the rotational shaft X, the air flow tends to be collected in the air passage in the portion of the circumferential wall 4c at the position 4c1 at which the speed of the air flow is fast and the dynamic pressure is high. Meanwhile, in the circumferential wall 4c in cross-section parallel to the rotational shaft X, the air volume of the air flow flowing through the portion at the position 4c2 in the circumferential wall 4c at which the speed of the air flow is slow and the dynamic pressure is low in the air passage is reduced. As a result, in the centrifugal fans 1 of Embodiment 2 and the modified examples, the air flow can be efficiently caused to flow along the inner peripheral surface of the circumferential wall 4c. As compared to the centrifugal fan including the standard circumferential wall SW having a logarithmic spiral shape of the related art, the centrifugal fan 1 can increase the distance between the axis C1 of the rotational shaft X and the circumferential wall 4c, and can increase the distance of the air passage while preventing the separation of the air flow. As a result, the centrifugal fan 1 can reduce the speed and convert the dynamic pressure to the static pressure, and can improve the air-sending efficiency while reducing the noise.

### Embodiment 3

### Air-Sending Device 30

FIG. 18 illustrates a configuration of the air-sending device 30 according to Embodiment 3 of the present disclosure. Sections having the same configurations as the centrifugal fan 1 in FIG. 1 to FIG. 14 are denoted by the same reference characters, and descriptions thereof are omitted. The air-sending device 30 according to Embodiment 3 is a ventilating fan or a desk fan, for example, and includes the centrifugal fan 1 according to Embodiment 1 or 2, and a case 7 accommodating the centrifugal fan 1. In the case 7, two opening ports, specifically, a suction port 71 and a discharge port 72 are formed. As shown in FIG. 18, the suction port 71 and the discharge port 72 are formed in opposite positions in the air-sending device 30. Note that the suction port 71 and the discharge port 72 do not necessarily need to be formed in opposite positions in the air-sending device 30. For example, either one of the suction port 71 and the discharge port 72 may be formed on the top or the bottom of the centrifugal fan 1. In the case 7, a space S1 including the portion in which the suction port 71 is formed and a space S2 including the portion in which the discharge port 72 is formed are partitioned by a partition plate 73. The centrifugal fan 1 is installed in a state in which the suction ports 5 are positioned in the space S1 in which the suction port 71 is formed and the discharge port 42a is positioned in the space S2 in which the discharge port 72 is formed.

When the fan 2 rotates, air is suctioned into the case 7 through the suction port 71. The air suctioned into the case 7 is guided by the bell mouths 3, and is suctioned by the fan 2. The air suctioned by the fan 2 is blown out to the radially outer side of the fan 2. The air blown out from the fan 2 is blown out from the discharge port 42a of the scroll casing 4 after passing through the inside of the scroll casing 4, and is blown out from the discharge port 72.

The air-sending device 30 according to Embodiment 3 includes the centrifugal fan 1 according to Embodiment 1 or 2, and hence can efficiently recover the pressure, and can improve the air-sending efficiency and reduce the noise.

### Embodiment 4

### Air-Conditioning Apparatus 40

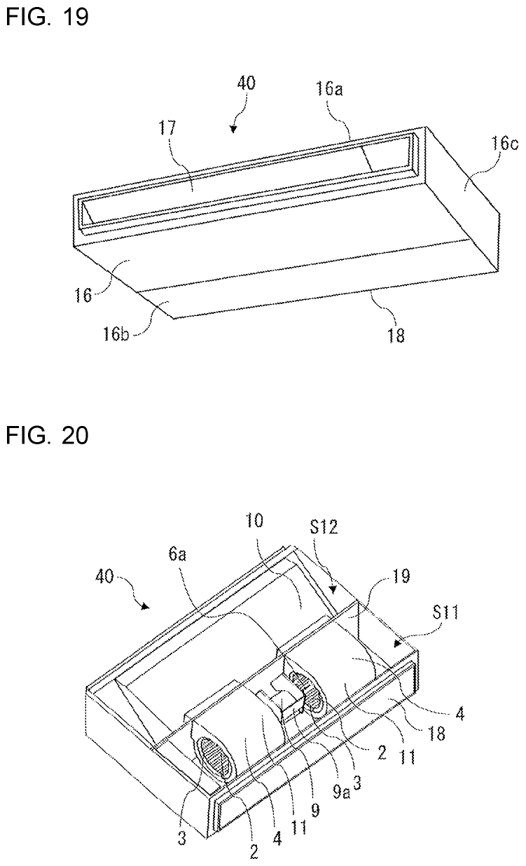

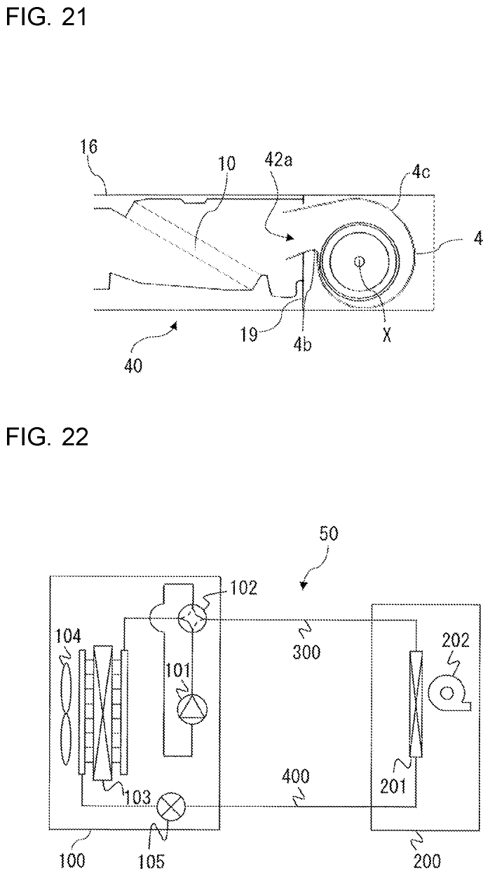

FIG. 19 is a perspective view of the air-conditioning apparatus 40 according to Embodiment 4 of the present disclosure. FIG. 20 illustrates an inner configuration of the air-conditioning apparatus 40 according to Embodiment 4 of the present disclosure. FIG. 21 is a cross-sectional view of the air-conditioning apparatus 40 according to Embodiment 4 of the present disclosure. Note that, in a centrifugal fan 11 used in the air-conditioning apparatus 40 according to Embodiment 4, sections having the same configurations as the centrifugal fan 1 in FIG. 1 to FIG. 14 are denoted by the same reference characters, and descriptions thereof are omitted. In FIG. 20, an upper surface portion 16a is omitted to illustrate the inner configuration of the air-conditioning apparatus 40. The air-conditioning apparatus 40 according to Embodiment 4 includes the centrifugal fan 1 of Embodiment 1 or 2, and a heat exchanger 10 disposed in a position facing the discharge port 42a of the centrifugal fan 1. The air-conditioning apparatus 40 according to Embodiment 4 includes a case 16 installed above a ceiling of an air-conditioned room. As shown in FIG. 19, the case 16 is formed in a cuboid shape including the upper surface portion 16a, a lower surface portion 16b, and side surface portions 16c. Note that the shape of the case 16 is not limited to a cuboid shape, and may be other shapes such as a cylindrical shape, a prismatic shape, a conical shape, a shape having a plurality of corners, and a shape having a plurality of curved portions.

### (Case 16)

The case 16 includes the side surface portion 16c at which a case discharge port 17 is formed as one of the side surface portions 16c. The shape of the case discharge port 17 is formed in a rectangular shape as shown in FIG. 19. Note that the shape of the case discharge port 17 is not limited to a rectangular shape, and may be a circular shape or an oval shape, for example, or may be other shapes. The case 16 includes the side surface portion 16c at which the case suction port 18 is formed on a surface opposite to the surface at which the case discharge port 17 is formed out of the side surface portions 16c. The shape of the case suction port 18 is formed in a rectangular shape as shown in FIG. 20. Note that the shape of the case suction port 18 is not limited to a rectangular shape, and may be a circular shape or an oval shape, for example, or may be other shapes. A filter configured to remove dust in the air, may be disposed on the case suction port 18.

In the case 16, two centrifugal fans 11, a fan motor 9, and the heat exchanger 10 are accommodated. Each of the centrifugal fans 11 includes the fan 2, and the scroll casing 4 in which the bell mouth 3 is formed. The shape of the bell mouth 3 of the centrifugal fan 11 is a shape similar to the shape of the bell mouth 3 of the centrifugal fan 1 of Embodiment 1. Each of the centrifugal fans 11 includes the fan 2 and the scroll casing 4 similar to the fan 2 and the scroll casing 4 of the centrifugal fan 1 according to Embodiment 1, but is different in that the fan motor 6 is not disposed in the scroll casing 4. The fan motor 9 is supported by a motor support 9a fixed to the upper surface portion 16a of the case 16. The fan motor 9 includes the output shaft 6a. The output shaft 6a is disposed to extend in a direction parallel to the surface at which the case suction port 18 is formed and the surface at which the case discharge port 17 is formed out of the side surface portions 16c. As shown in FIG. 20, in the air-conditioning apparatus 40, two fans 2 are mounted on the output shaft 6a. The fans 2 form the flow of the air suctioned into the case 16 from the case suction port 18 and blown out to the air-conditioned space from the case discharge port 17. Note that the number of the fans 2 disposed in the case 16 is not limited to two and may be one or three or more.

As shown in FIG. 20, the centrifugal fans 11 are installed in the partition plate 19, and the inner space of the case 16 is partitioned into a space S11 on the suction side of the scroll casing 4 and a space S12 on the blow out side of the scroll casing 4 by the partition plate 19.

As shown in FIG. 21, the heat exchanger 10 is disposed in a position facing the discharge ports 42a of the centrifugal fan 11, and is disposed on the air passage of the air discharged from the centrifugal fan 11 in the case 16. The heat exchanger 10 adjusts the temperature of the air suctioned into the case 16 from the case suction port 18 and blown out to the air-conditioned space from the case discharge port 17. Note that a well-known structure can be applied to the heat exchanger 10.

When the fans 2 rotate, the air in the air-conditioned space is suctioned into the case 16 through the case suction port 18. The air suctioned into the case 16 is the guided by bell mouths 3 and is suctioned by the fans 2. The air suctioned by the fans 2 is blown out toward the radially outer side of the fans 2. The air blown out from the fans 2 passes through the inside of the scroll casings 4. Then, the air is blown out from the discharge ports 42a of the scroll casings 4 and is supplied to the heat exchanger 10. When the air supplied to the heat exchanger 10 passes through the heat exchanger 10, the heat thereof is exchanged and the humidity thereof is adjusted. The air passing through the heat exchanger 10 is blown out to the air-conditioned space from the case discharge port 17.

The air-conditioning apparatus 40 according to Embodiment 4 includes the centrifugal fan 1 according to Embodiment 1 or 2, and hence can efficiently recover the pressure, and can improve the air-sending efficiency and reduce the noise.

### Embodiment 5

### Refrigeration Cycle Apparatus 50

FIG. 22 illustrates the configuration of the refrigeration cycle apparatus 50 according to Embodiment 5 of the present disclosure. Note that, in the centrifugal fan 1 used in the refrigeration cycle apparatus 50 according to Embodiment 5, sections having the same configurations as those of the centrifugal fan 1 or the centrifugal fan 11 in FIG. 1 to FIG. 14 are denoted by the same reference characters, and descriptions thereof are omitted. The refrigeration cycle apparatus 50 according to Embodiment 5 conditions air by heating or cooling the inside of a room by moving the heat between the outside air and the indoor air via refrigerant. The refrigeration cycle apparatus 50 according to Embodiment 5 includes an outdoor unit 100 and an indoor unit 200. In the refrigeration cycle apparatus 50, a refrigerant circuit in which the refrigerant circulates is formed by connecting the outdoor unit 100 and the indoor unit 200 to each other by pipes, specifically, a refrigerant pipe 300 and a refrigerant pipe 400. The refrigerant pipe 300 is a gas pipe through which refrigerant in a gas phase flows, and the refrigerant pipe 400 is a liquid pipe through which refrigerant in a liquid phase flows. Note that two-phase gas-liquid refrigerant may flow through the refrigerant pipe 400. In the refrigerant circuit of the refrigeration cycle apparatus 50, a compressor 101, a flow switching device 102, an outdoor heat exchanger 103, an expansion valve 105, and an indoor heat exchanger 201 are sequentially connected to each other via the refrigerant pipes.

### (Outdoor Unit 100)

The outdoor unit 100 includes the compressor 101, the flow switching device 102, the outdoor heat exchanger 103, and the expansion valve 105. The compressor 101 compresses and discharges the suctioned refrigerant. The compressor 101 may include an inverter device, and may be formed to be able to change the capacity of the compressor 101 by changing the operating frequency by the inverter device. Note that the capacity of the compressor 101 is the amount of the refrigerant sent out per unit time. The flow switching device 22 is a four-way valve, for example, and is a device in which the direction of the refrigerant flow passage is switched. The refrigeration cycle apparatus 50 can realize the heating operation or the cooling operation by switching the flow of the refrigerant with use of the flow switching device 102 on the basis of the instruction from a controller (not shown).

The outdoor heat exchanger 103 exchanges the heat between the refrigerant and the outdoor air. The outdoor heat exchanger 103 functions as an evaporator at the time of the heating operation, and exchanges the heat between low-pressure refrigerant flowing into the outdoor heat exchanger 103 from the refrigerant pipe 400 and the outdoor air, to thereby evaporate and gasify the refrigerant. The outdoor heat exchanger 103 functions as a condenser at the time of the cooling operation, and exchanges the heat between the refrigerant compressed in the compressor 101 flowing into the outdoor heat exchanger 103 from the flow switching device 102 side and the outdoor air, to thereby condense and liquefy the refrigerant. In the outdoor heat exchanger 103, an outdoor fan 104 is provided to increase the efficiency of the heat exchange between the refrigerant and the outdoor air. Regarding the outdoor fan 104, an inverter device may be mounted, and the rotation speed of the fan may be changed by changing the operating frequency of a fan motor. The expansion valve 105 is an expansion device (flow rate control unit), and functions as an expansion valve by adjusting the flow rate of the refrigerant flowing through the expansion valve 105. The expansion valve 105 adjusts the pressure of the refrigerant by changing the opening degree. For example, the expansion valve 105 adjusts the opening degree on the basis of the instruction from the controller (not shown) and other units when the expansion valve 105 is made of an electronic expansion valve or other valves.

### (Indoor Unit 200)

The indoor unit 200 includes the indoor heat exchanger 201 configured to exchange the heat between the refrigerant and the indoor air, and an indoor fan 202 configured to adjust the flow of the air with which the indoor heat exchanger 201 performs heat exchange. The indoor heat exchanger 201 functions as a condenser at the time of the heating operation. The indoor heat exchanger 201 performs heat exchange between the refrigerant flowing into the indoor heat exchanger 201 from the refrigerant pipe 300 and the indoor air, condenses and liquefies the refrigerant, and causes the refrigerant to flow out to the refrigerant pipe 400 side. The indoor heat exchanger 201 functions as an evaporator at the time of the cooling operation. The indoor heat exchanger 201 performs heat exchange between the refrigerant placed in the low-pressure state by the expansion valve 105 and the indoor air, and causes the refrigerant to draw the heat from the air, so that the refrigerant is evaporated and vaporized. Then, the indoor heat exchanger 201 causes the refrigerant to flow out to the pipe 300 side. The indoor fan 202 is provided to face the indoor heat exchanger 201. The centrifugal fan 1 according to Embodiment 1 or 2 and the centrifugal fan 11 according to Embodiment 5 are applied to the indoor fan 202. The operation speed of the indoor fan 202 is determined by the setting by a user. An inverter device may be mounted on the indoor fan 202, and the rotation speed of the fan 2 may be changed by changing the operating frequency of the fan motor 6.

### Operation Example of Refrigeration Cycle Apparatus 50

Next, an operation of the cooling operation is described as an operation example of the refrigeration cycle apparatus 50. High-temperature high-pressure gas refrigerant compressed by and discharged from the compressor 101 flows into the outdoor heat exchanger 103 via the flow switching device 102. The gas refrigerant flowing into the outdoor heat exchanger 103 is condensed by heat exchange with the outside air blown by the outdoor fan 104, is turned to be low-temperature refrigerant, and flows out from the outdoor heat exchanger 103. The expansion valve 105 expands the refrigerant flowing out of the outdoor heat exchanger 103 and reduces the pressure thereof. As a result, the refrigerant is turned to be low-temperature low-pressure two-phase gas-liquid refrigerant. The two-phase gas-liquid refrigerant flows into the indoor heat exchanger 201 of the indoor unit 200, and is evaporated by the heat exchange with the indoor air blown by the indoor fan 202. As a result, the two-phase gas-liquid refrigerant is turned to be low-temperature low-pressure gas refrigerant and flows out from the indoor heat exchanger 201. At this time, the heat of the indoor air is absorbed by the refrigerant and the indoor air cooled. As a result, the indoor air is turned to be conditioned air (blown air), and is blown out into the room (air-conditioned space) from the air outlet of the indoor unit 200. The gas refrigerant flowing out from the indoor heat exchanger 201 is suctioned by the compressor 101 via the flow switching device 102 and is compressed again. The operation above is repeated.

Next, an operation of the heating operation is described as an operation example of the refrigeration cycle apparatus 50. The high-temperature high-pressure gas refrigerant compressed by and discharged from the compressor 101 flows into the indoor heat exchanger 201 of the indoor unit 200 via the flow switching device 102. The gas refrigerant flowing into the indoor heat exchanger 201 is condensed by the heat exchange with the indoor air blown by the indoor fan 202, is turned to be low-temperature refrigerant, and flows out from the indoor heat exchanger 201. At this time, the indoor air heated by receiving heat from the gas refrigerant is turned to be conditioned air (blown air), and is blown out into the room (air-conditioned space) from the air outlet of the indoor unit 200. The expansion valve 105 expands the refrigerant flowing out from the indoor heat exchanger 201 and reduces the pressure of the refrigerant. As a result, the refrigerant is turned to be low-temperature low-pressure two-phase gas-liquid refrigerant. The two-phase gas-liquid refrigerant flows into the outdoor heat exchanger 103 of the outdoor unit 100, and is evaporated by the heat exchange with the outside air blown by the outdoor fan 104. As a result, the two-phase gas-liquid refrigerant is turned to be low-temperature low-pressure gas refrigerant and flows out from the outdoor heat exchanger 103. The gas refrigerant flowing out from the outdoor heat exchanger 103 is suctioned by the compressor 101 via the flow switching device 102, and is compressed again. The operation above is repeated.

The refrigeration cycle apparatus 50 according to Embodiment 5 includes the centrifugal fan 1 according to Embodiment 1 or 2, and hence can efficiently recover the pressure, and can improve the air-sending efficiency and reduce the noise.

The configurations described in the embodiments given above describe one example of the content of the present disclosure, and can be combined with other well-known technologies. Further, a part of the configuration can be omitted or changed without departing from the gist of the present disclosure.

### REFERENCE SIGNS LIST

1 centrifugal fan 2 fan 2a main plate 2a1 circumferential portion 2b boss portion 2c side plate 2d blade 2e suction port 3 bell mouth 3a upstream end 3b downstream end 4 scroll casing 4a side wall 4b tongue portion 4c circumferential wall 4d protruding portion 5 suction port 6 fan motor 6a output shaft 7 case 9 fan motor 9a motor support 10 heat exchanger 11 centrifugal fan 16 case 16a upper surface portion 16 fan surface portion 16c side surface portion 17 case discharge port 18 case suction port 19 partition plate 22 flow switching device 30 air-sending device 40 air-conditioning apparatus 41 scroll portion 41a first end 41b second end 42 discharge portion 42a discharge port 50 refrigeration cycle apparatus 51 first extended portion 52 second extended portion 53 third extended portion 54 fourth extended portion 71 suction port 72 discharge port 73 partition plate 100 outdoor unit 101 compressor 102 flow switching device 103 outdoor heat exchanger 104 outdoor fan 105 expansion valve 200 indoor unit 201 indoor heat exchanger 202 indoor fan 300 refrigerant pipe 400 refrigerant pipe

1-12. (canceled)

13. An air-conditioning apparatus, comprising:
a centrifugal fan and
a heat exchanger disposed in a position facing a discharge port of the centrifugal fan;
the centrifugal fan including:
a fan including a main plate having a disk-shape, and a plurality of blades installed on a circumferential portion of the main plate; and
a scroll casing configured to house the fan,
the scroll casing including
a discharge portion forming a discharge port from which an air flow generated by the fan is discharged, and
a scroll portion including
a side wall covering the fan in an axis direction of a rotational shaft of the fan, and provided with a suction port configured to suction air,
a circumferential wall encircling the fan in a radial direction of the rotational shaft, and
a tongue portion provided between the discharge portion and the circumferential wall, and configured to guide the air flow generated by the fan to the discharge port,
in comparison with a centrifugal fan including a standard circumferential wall having a logarithmic spiral shape in cross-section perpendicular to the rotational shaft of the fan,
in the circumferential wall, at a first end being a boundary between the circumferential wall and the tongue portion and at a second end being a boundary between the circumferential wall and the discharge portion, a distance L1 between an axis of the rotational shaft and the circumferential wall being equal to a distance L2 between the axis of the rotational shaft and the standard circumferential wall,
the distance L1 being greater than or equal to the distance L2 between the first end and the second end of the circumferential wall,
the circumferential wall including an extended portion between the first end and the second end of the circumferential wall, the extended portion comprising maximum points each having a length being a difference LH between the distance L1 and the distance L2,
wherein the circumferential wall bulges out, at a position facing the circumferential portion of the main plate, in a direction parallel to the rotational shaft, and the distance L1 is greatest at a position facing the circumferential portion of the main plate in the direction parallel to the rotational shaft in the circumferential wall.

14. The air-conditioning apparatus of claim 13, wherein,
at an angle θ shifted from a first reference line in a direction of rotation of the fan between the first reference line and a second reference in cross-section perpendicular to the rotational shaft of the fan, the first reference line connecting the axis of the rotational shaft and the first end to each other, the second reference line connecting the axis of the rotational shaft and the second end to each other,
the extended portion includes:
a first maximum point P1 in a section in which the angle θ is 0 degrees or more and less than 90 degrees;
a second maximum point P2 in a section in which the angle θ is 90 degrees or more and less than 180 degrees; and
a third maximum point P3 in a section in which the angle θ is 180 degrees or more and less than an angle α formed by the second reference line.

15. The air-conditioning apparatus of claim 14, wherein, when:
a point at which the difference LH is smallest in a section in which the angle θ is 0 degrees or more and equal to or less than an angle at which the first maximum point P1 is positioned is a first minimum point U1;
a point at which the difference LH is smallest in a section in which the angle θ is 90 degrees or more and equal to or less than an angle at which the second maximum point P2 is positioned is a second minimum point U2;
a point at which the difference LH is smallest in a section in which the angle θ is 180 degrees or more and equal to or less than an angle at which the third maximum point P3 is positioned is a third minimum point U3;
a difference L11 between the distance L1 at the first maximum point P1 and the distance L1 at the first minimum point U1 relative to an increase θ1 of the angle θ from the first minimum point U1 to the first maximum point P1 is an extension rate A;
a difference L22 between the distance L1 at the second maximum point P2 and the distance L1 at the second minimum point U2 relative to an increase θ2 of the angle θ from the second minimum point U2 to the second maximum point P2 is an extension rate B; and
a difference L33 between the distance L1 at the third maximum point P3 and the distance L1 at the third minimum point U3 relative to an increase θ3 of the angle θ from the third minimum point U3 to the third maximum point P3 is an extension rate C,
a relationship of the extension rate B>the extension rate C, and the extension rate B≥the extension rate A>the extension rate C, or a relationship of the extension rate B>the extension rate C, and the extension rate B>the extension rate C≥the extension rate A is satisfied.

16. The air-conditioning apparatus of claim 14, wherein, when:
a point at which the difference LH is smallest in a section in which the angle θ is 0 degrees or more and equal to or less than an angle at which the first maximum point P1 is positioned is a first minimum point U1;
a point at which the difference LH is smallest in a section in which the angle θ is 90 degrees or more and equal to or less than an angle at which the second maximum point P2 is positioned is a second minimum point U2;
a point at which the difference LH is smallest in a section in which the angle θ is 180 degrees or more and equal to or less than an angle at which the third maximum point P3 is positioned is a third minimum point U3;
a difference L11 between the distance L1 at the first maximum point P1 and the distance L1 at the first minimum point U1 relative to an increase θ1 of the angle θ from the first minimum point U1 to the first maximum point P1 is an extension rate A;
a difference L22 between the distance L1 at the second maximum point P2 and the distance L1 at the second minimum point U2 relative to an increase θ2 of the angle θ from the second minimum point U2 to the second maximum point P2 is an extension rate B; and
a difference L33 between the distance L1 at the third maximum point P3 and the distance L1 at the third minimum point U3 relative to an increase θ3 of the angle θ from the third minimum point U3 to the third maximum point P3 is an extension rate C,
a relationship of the extension rate C>the extension rate B≥the extension rate A is satisfied.

17. The air-conditioning apparatus of any one of claims 14, wherein:
at the angle θ shifted from the first reference line in the direction of the rotation of the fan between the first reference line and the second reference in cross-section perpendicular to the rotational shaft of the fan, the first reference line connecting the axis of the rotational shaft and the first end to each other, the second reference line connecting the axis of the rotational shaft and the second end to each other,
the extended portion includes:
a first extended portion including the first maximum point P1 in the section in which the angle θ is 0 degrees or more and less than 90 degrees;
a second extended portion including the second maximum point P2 in the section in which the angle θ is 90 degrees or more and less than 180 degrees; and
a third extended portion including the third maximum point P3 in the section in which the angle θ is 180 degrees or more and less than an angle α formed by the second reference line; and
the distance L1 is greater than the distance L2 in the circumferential wall forming a region from the second extended portion to the third extended portion.

18. The air-conditioning apparatus of claim 13, wherein,
at an angle θ shifted from a first reference line in a direction of rotation of the fan between the first reference line and a second reference in cross-section perpendicular to the rotational shaft of the fan, the first reference line connecting the axis of the rotational shaft and the first end to each other, the second reference line connecting the axis of the rotational shaft and the second end to each other,
the extended portion includes:
a second extended portion including a second maximum point P2 in a section in which the angle θ is 90 degrees or more and less than 180 degrees; and
a third extended portion including a third maximum point P3 in a section in which the angle θ is 180 degrees or more and less than the angle α formed by the second reference line; and
the distance L1 is greater than the distance L2 in the circumferential wall forming a region from the second extended portion to the third extended portion.

19. The air-conditioning apparatus of claim 15, wherein, when:
a difference L44 between the distance L1 at the second minimum point U2 and the distance L1 at the first maximum point P1 relative to an increase θ11 of the angle θ from the first maximum point P1 to the second minimum point U2 is an extension rate D;
a difference L55 between the distance L1 at the third minimum point U3 and the distance L1 at the second maximum point P2 relative to an increase θ22 of the angle θ from the second maximum point P2 to the third minimum point U3 is an extension rate E;
a difference L66 between the distance L1 at the angle α and the L1 at the third maximum point P3 relative to an increase θ33 of the angle θ from the third maximum point P3 to the angle α is an extension rate F; and
the distance L2 between the axis of the rotational shaft and the standard circumferential wall relative to the increase of the angle θ is an extension rate J, the extension rate J>the extension rate D≥0, the extension rate J>the extension rate E≥0, and the extension rate J>the extension rate F≥0 are satisfied.

20. The air-conditioning apparatus of claim 13, wherein the circumferential wall has a protruding portion in a circumferential direction of the rotational shaft, the protruding portion protruding to the radial direction of the rotational shaft.

21. A refrigeration cycle apparatus, comprising the air-conditioning apparatus of claim 13.
